(19) United States
(12) Patent Application Publication
(10) Pub. No.: US 2015/0185586 A1
(43) Pub. Date: Jul. 2, 2015

(54) MOTOR DRIVING APPARATUS AND METHOD, AND VOICE COIL MOTOR SYSTEM USING THE SAME

(71) Applicant: SAMSUNG ELECTRO-MECHANICS CO., LTD., Suwon-Si (KR)

(72) Inventor: Wan Cheol YANG, Suwon-Si (KR)

(73) Assignee: SAMSUNG ELECTRO-MECHANICS CO., LTD., Suwon-Si (KR)

(21) Appl. No.: 14/226,610

(22) Filed: Mar. 26, 2014

(30) Foreign Application Priority Data
Dec. 30, 2013 (KR) 10-2013-0166589

(51) Int. Cl. G03B 13/36; H04N 5/232

(52) U.S. Cl. CPC G03B 13/36; H04N 5/23212

(57) ABSTRACT

A motor driving apparatus may include: a weight generating unit generating a weight of an external input signal using a damping ratio of a motor apparatus; and a driving signal generating unit generating a driving signal including a first signal generated by reflecting the weight in the external input signal and a second signal corresponding to the external input signal.

### CROSS-REFERENCE TO RELATED APPLICATION

This application claims the benefit of Korean Patent Application No. 10-2013-0166589, filed on Dec. 30, 2013, with the Korean Intellectual Property Office, the disclosure of which is incorporated herein by reference.

### BACKGROUND

The present disclosure relates to a motor driving apparatus and method, and a voice coil motor system using the same.

Auto-focusing technology, technology allowing for the focusing of a lens through a lens being automatically moved by a predetermined amount using an electric motor, a piezoelectric element, or the like, has been applied to cameras, smartphone camera modules, and the like.

In auto-focusing technology, a lens is focused by sensing a distance to an imaging object and then moving the lens to a position at which an optimal image is formed by an auto-focusing algorithm using an image output signal from a sensor.

In order to perform auto-focusing, a motor, that is, an actuator, is required. Actuators can be classified as stepping motor (SM) type actuators, piezoelectric type actuators, voice coil motor (VCM) type actuators, and others, depending on a driving scheme employed therein.

Among such actuators, the voice coil motor type actuator has been used in mobile devices, in which miniaturization is important, such as cellular phones. That is, such a voice coil motor is driven to move a lens, such that auto-focusing, for focusing a camera lens on a specific subject, may be performed.

A general voice coil motor may not satisfy a requirement for miniaturization in the case of a closed loop control. Therefore, a scheme of controlling a voice coil motor is generally implemented with an open loop.

However, in the case of controlling the voice coil motor with such an open loop, a unique resonance phenomenon may occur therein. Such a resonance phenomenon may cause a ringing phenomenon at the time of driving a voice coil motor, thereby having an effect on an auto-focusing function of a camera or causing malfunctioning thereof.

### SUMMARY

An exemplary embodiment in the present disclosure may provide a motor driving apparatus and method allowing for precise controlling of the driving of a voice coil motor by generating a driving signal through reflection of a weight using a damping ratio of a motor apparatus to prevent a resonance phenomenon of the voice coil motor and a ringing phenomenon due to the resonance phenomenon, and a voice coil motor system using the same.

According to an exemplary embodiment in the present disclosure, a motor driving apparatus may include: a weight generating unit generating a weight of an external input signal using a damping ratio of a motor apparatus; and a driving signal generating unit generating a driving signal including a first signal generated by reflecting the weight in the external input signal and a second signal corresponding to the external input signal.

The weight may be linearly proportional to the damping ratio of the motor apparatus.

The driving signal may be a step signal including a first signal continued until a first time and a second signal continued after the first time.

The driving signal generating unit may include: a synthesizer generating the first signal by reflecting the weight in the external input signal; a selector receiving the first signal and the second signal and outputting the first signal or the second signal; and a timing controller determining output timing of the first signal or the second signal and providing the determined output timing to the selector.

The motor driving apparatus may further include a filter unit low-pass-filtering the driving signal output from the driving signal generating unit.

The external input signal and the driving signal may be digital signals, and the motor driving apparatus may further include a digital-to-analog converting unit performing digital-to-analog conversion on the driving signal and providing the converted signal to the motor apparatus.

The weight generating unit may calculate the weight a using the following Equation:

α=p(1)*zeta+p(2)

where zeta is the damping ratio, and p(1) and p(2) indicate fitting coefficients.

According to an exemplary embodiment in the present disclosure, a voice coil motor system may include: a voice coil motor apparatus; and a motor driving apparatus generating a driving signal using a damping ratio of the voice coil motor apparatus, wherein the driving signal is generated by reflecting a weight generated using the damping ratio in an external input signal.

The motor driving apparatus may include: a weight generating unit generating the weight of the external input signal using the damping ratio of the voice coil motor apparatus; and a driving signal generating unit generating a driving signal including a first signal generated by reflecting the weight in the external input signal and a second signal corresponding to the external input signal.

The driving signal generating unit may include: a synthesizer generating the first signal by reflecting the weight in the external input signal; a selector receiving the first signal and the second signal and outputting the first signal or the second signal; and a timing controller determining output timing of the first signal or the second signal and providing the determined output timing to the selector.

The weight generating unit may calculate the weight a using the following Equation:

α=p(1)*zeta+p(2)

where zeta is the damping ratio, and p(1) and p(2) indicate fitting coefficients.

According to an exemplary embodiment in the present disclosure, a motor driving method performed by a motor driving apparatus for driving a motor apparatus may include: generating a weight of an external input signal using a damping ratio of the motor apparatus; generating a first signal by reflecting the weight in the external input signal; generating a second signal corresponding to the external input signal; and generating a driving signal including the first signal and the second signal.

In the generating of the weights, the weight a may be calculated using the following Equation:

α=p(1)*zeta+p(2)

where zeta is the damping ratio, and p(1) and p(2) indicate fitting coefficients.

The driving signal may be a digital signal and be a step signal including a first signal continued until a first time and a second signal continued after the first time.

The generating of the weight, the generating of the first signal, the generating of the second signal, and the generating of the driving signal may be repeatedly performed during each period of the driving signal.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a graph showing an example of a period of a step response waveform of a voice coil motor;

FIG. 2 is a graph showing changes in A₁ and A₂ depending on a variable damping ratio in a voice coil motor;

FIG. 3 is a reference diagram showing a coefficient A1 estimated using a fitting coefficient;

FIG. 4 is a configuration diagram showing an example of a voice coil motor system according to an exemplary embodiment of the present disclosure;

FIG. 5 is a reference diagram showing an example of a weight generating unit of FIG. 4;

FIG. 6 is a reference diagram showing an example of a timing controller of FIG. 4;

FIG. 7 is a reference diagram showing an example of a filter unit of FIG. 4;

FIG. 8 is a reference diagram showing an example of a driving signal output from a motor driving apparatus;

FIGS. 9 and 10 are reference graphs showing a vibration error according to the related art;

FIG. 11 is a reference graph showing a vibration error according to an exemplary embodiment of the present disclosure; and

FIG. 12 is a flow chart for describing a motor driving method according to an exemplary embodiment of the present disclosure.

### DETAILED DESCRIPTION

Exemplary embodiments of the present disclosure will now be described in detail with reference to the accompanying drawings.

In addition, hereinafter, a motor apparatus itself will be called a motor apparatus, and a system including a motor driving apparatus for driving the motor apparatus and the motor apparatus will be called a motor system.

Hereinafter, a transfer function of a voice coil motor according to an exemplary embodiment of the present disclosure will be described. The following description may be applied to a weight generating unit and a driving signal generating unit to be described below.

The transfer function of the voice coil motor, which is a 2nd order dynamic system, may be mathematically modeled as represented by Mathematical Equation 1.

$$G ( s ) = \frac{Y ( s )}{U ( s )} = \frac{{ω}_{n}^{2}}{{s}^{2} + 2 {ϛω}_{n} s + {ω}_{n}^{2}} \qquad [ Mathematical Equation 1 ]$$

Here, ωₙ, is a natural frequency, and ζ is a damping ratio.

In a damped case (0<ζ<1), a transfer function has a complex pole as represented by Mathematical Equation 2.

$$[ Mathematical Equation 2 ]$$

$$\frac{Y ( s )}{U ( s )} = \frac{{ω}_{n}^{2}}{( s + {ϛω}_{n} + {jω}_{d} ) ( s + {ϛω}_{n} - {jω}_{d} ) }$$

Here, ω_{d}=ωₙ\sqrt{1−ζ²} is a damped natural frequency.

When an input signal is a unit-step signal, that is, when U(s)=1/s, a response (Y(s)) of a system may be represented by Mathematical Equation 3.

$$Y ( s ) = \frac{{ω}_{n}^{2}}{( {s}^{2} + 2 {ϛω}_{n} s + {ω}_{n}^{2} ) s} \qquad [ Mathematical Equation 3 ]$$

Mathematical Equation 3 may be replaced by Mathematical Equation 4 in order to facilitate inverse Laplace transform.

$$[ Mathematical Equation 4 ]$$

$$\begin{matrix}Y ( s ) = \frac{1}{s} \frac{s + 2 {ϛω}_{n}}{( {s}^{2} + 2 {ϛω}_{n} s + {ω}_{n}^{2} )} \\ = \frac{1}{s} - \frac{s + {ϛω}_{n}}{{( s + {ϛω}_{n} )}^{2} + {ω}_{d}^{2}} - \frac{{ϛω}_{n}}{{( s + {ϛω}_{n} )}^{2} + {ω}_{d}^{2}}\end{matrix}$$

The response (y(t)) of the system to the unit step input may be represented by Mathematical Equation 5 using the inverse Laplace transform formula.

$$[ Mathematical Equation 5 ]$$

$${L}^{- 1} [ \frac{s + {ϛω}_{n}}{{( s + {ϛω}_{n} )}^{2} + {ω}_{d}^{2}} ] = {e}^{- {ϛω}_{n} t} cos {ω}_{d} t$$

$${L}^{- 1} [ \frac{{ω}_{d}}{{( s + {ϛω}_{n} )}^{2} + {ω}_{d}^{2}} ] = {e}^{- {ϛω}_{n} t} sin {ω}_{d} t$$

Therefore, the response to the unit step may be represented by Mathematical Equation 6.

$$[ Mathematical Equation 6 ]$$

$${L}^{- 1} [ Y ( s ) ] = y ( t ) = 1 - {e}^{- {ϛω}_{n} t} ( cos {ω}_{d} t + \frac{ϛ}{\sqrt{1 - {ϛ}^{2}}} sin {ω}_{d} t ) , t \geq 0$$

Here, an error signal means residual vibrations and is represented by Mathematical Equation 7.

$$[ Mathematical Equation 7 ]$$

$$\begin{matrix}e ( t ) = r ( t ) - y ( t ) \\ = {e}^{- {ϛω}_{n} t} ( cos {ω}_{d} t + \frac{ϛ}{\sqrt{1 - {ϛ}^{2}}} sin {ω}_{d} t ) , t \geq 0\end{matrix}$$

As a result, a ringing phenomenon of the voice coil motor may be suppressed by suppressing the error signal.

Here, when it is assumed that step inputs of A₁ and A₂ have been applied at times t₁ and t₂, respectively, the respective error signals may be represented by Mathematical Equation 8.

$$[ Mathematical Equation 8 ]$$

$$e ( {t}_{1} ) = {A}_{1} {e}^{- {ϛω}_{n} {t}_{1}} ( cos {ω}_{d} {t}_{1} + \frac{ϛ}{\sqrt{1 - {ϛ}^{2}}} sin {ω}_{d} {t}_{1} ) , {t}_{1} \geq 0$$

$$e ( {t}_{2} ) = {A}_{2} {e}^{- {ϛω}_{n} {t}_{2}} ( cos {ω}_{d} {t}_{2} + \frac{ϛ}{\sqrt{1 - {ϛ}^{2}}} sin {ω}_{d} {t}_{2} ) , {t}_{2} \geq {t}_{1}$$

Since residual vibrations of the system correspond to the sum of the respective error signals, they may be represented by Mathematical Equation 9.

$$[ Mathematical Equation 9 ]$$

$$e ( {t}_{1} ) + e ( {t}_{2} ) = {A}_{1} {e}^{- {ϛω}_{n} {t}_{1}} cos {ω}_{d} {t}_{1} + {A}_{2} {e}^{- {ϛω}_{n} {t}_{2}} cos {ω}_{d} {t}_{2} + \frac{ϛ}{\sqrt{1 - {ϛ}^{2}}} ( {A}_{1} {e}^{- {ϛω}_{n} {t}_{1}} sin {ω}_{d} {t}_{1} + {A}_{2} {e}^{- {ϛω}_{n} {t}_{2}} sin {ω}_{d} {t}_{2} )$$

A condition for removing the residual vibrations of the system needs to satisfy Mathematical Equation 10.

[Mathematical Equation 10]

A₁e^{-ζω}^{ₙ}^{t} cos ω_{d}t₁+A₂e^{-ζω}^{ₙ}^{tt}^{₂} cos ω_{d}t₂=0

A₁e^{-ζω}^{ₙ}^{t}^{₁} sin ω_{d}t₁+A₂e^{-ζω}^{ₙ}^{t}^{₂} sin ω_{d}t₂=0

Here, when it is assumed that Mathematical Equation 10 is normalized so that a first step input time is 0 and the sum of two step inputs is 1, Mathematical Equation 11 may be derived.

[Mathematical Equation 11]

t₁=0,A₁+A₂=1

When t₁=0 is substituted into each of the above system response error equations, Mathematical Equation 12 may be derived.

[Mathematical Equation 12]

A₁+A₂e^{-ζω}^{ₙ}^{t}^{₂} cos ω_{d}t₂=0

A₂e^{-ζω}^{ₙ}^{t}^{₂} sin ω_{d}t₂=0

A result as represented by Mathematical Equation 13 may be obtained from Mathematical Equation 12.

$${ω}_{d} {t}_{2} = π \\ {t}_{2 =} \frac{π}{{ω}_{d}} = \frac{π}{2 π {f}_{d}} = \frac{{T}_{d}}{2} \qquad [ Mathematical Equation 13 ]$$

As a result, it may be appreciated that t₂ should have a time difference from t₁ by 0.5 T_{d}.

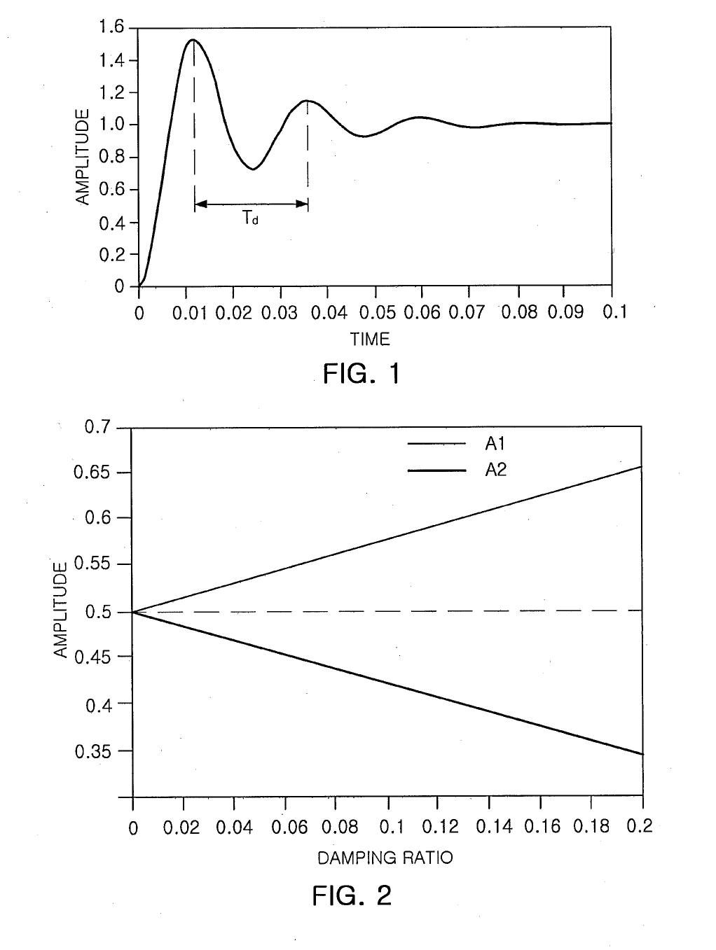

Here, T_{d} means a period of a step response waveform of a voice coil motor. FIG. 1 shows an example of a period of a step response waveform of a voice coil motor.

Here, when a condition such as Mathematical Equation 14 is used,

$${A}_{2} = 1 - {A}_{1} , {t}_{2} = \frac{π}{{ω}_{d}} \qquad [ Mathematical Equation 14 ]$$

Mathematical Equation 15 may be obtained as follows.

$${A}_{1} + ( 1 - {A}_{1} ) {e}^{- {ϛω}_{n} \frac{n}{{ω}_{d}}} cos {ω}_{d} \frac{π}{{ω}_{d}} = 0 \qquad [ Mathematical Equation 15 ]$$

When these are arranged, Mathematical Equation 16 may be obtained.

$${A}_{1} - ( 1 - {A}_{1} ) {e}^{- ϛ \frac{n}{\sqrt{1 - {ϛ}^{2}}}} = 0 \\ {A}_{1} - 1 - {A}_{1} {e}^{- ϛ \frac{n}{\sqrt{1 - {ϛ}^{2}}}} = 0 \\ {A}_{1} ( 1 + {e}^{- ϛ \frac{n}{\sqrt{1 - {ϛ}^{2}}}} ) = 1 \\ ∴ {A}_{1} = \frac{1}{1 + {e}^{- ϛ \frac{n}{\sqrt{1 - {ϛ}^{2}}}}} \qquad [ Mathematical Equation 16 ]$$

Therefore, a magnitude A₁ of a first step input and a magnitude A₂ of a second step input may be represented by

Mathematical Equation 17.

$$[ Mathematical Equation 17 ]$$

$${A}_{1} = \frac{1}{1 + G} , {A}_{2} = 1 - {A}_{1} = \frac{G}{1 + G} , G = {e}^{\frac{- ϛ n}{\sqrt{1 - {ϛ}^{2}}}}$$

From Mathematical Equation 17, a condition for driving a voice coil motor (VCM) using a series of step signals without a residual vibration phenomenon may be represented by Mathematical Equation 18.

[Mathematical Equation 18]

e(t)=e(t₁)+e(t₂)→0

Therefore, it may be appreciated that a time difference between two input signals should be 0.5 T_{d} and magnitudes of the input signals are A₁ and A₂ and satisfy Mathematical Equation 19.

$$[ Mathematical Equation 19 ]$$

$${t}_{1} = 0 , {t}_{2} = \frac{{T}_{d}}{2} , {A}_{1} = \frac{1}{1 + G} , {A}_{2} = \frac{G}{1 + G} , G = {e}^{\frac{- ϛ n}{\sqrt{1 - {ϛ}^{2}}}}$$

As a result, amplitude coefficients A₁ and A₂ are functions associated with a damping ratio. In exemplary embodiments of the present disclosure, a driving signal is generated using the damping ratio, such that a ringing phenomenon of the voice coil motor may be prevented.

FIG. 2 is a graph showing changes in A₁ and A₂ depending on a variable damping ratio in a voice coil motor. FIG. 2 shows that a damping ratio is changed from 0 to 0.2.

As shown in FIG. 2, in the case in which the damping ratio is 0, A₁ and A₂ which are 0.5, respectively, may be the same as each other. However, in the case in which the damping ratio is increased, A₁ and A₂ may become different from each other.

That is, A₁ may be monotonously increased when the damping ratio is increased, and A₂ may be monotonously decreased when the damping ratio is increased.

In addition, it may be appreciated that changes in A₁ and A₂ are substantially linear in a section in which the damping ratio is less than 0.2. Therefore, in various exemplary embodiments of the present disclosure, a relationship between a coefficient A₁ (weight) and the damping ratio may be used as a simple linear fitting function.

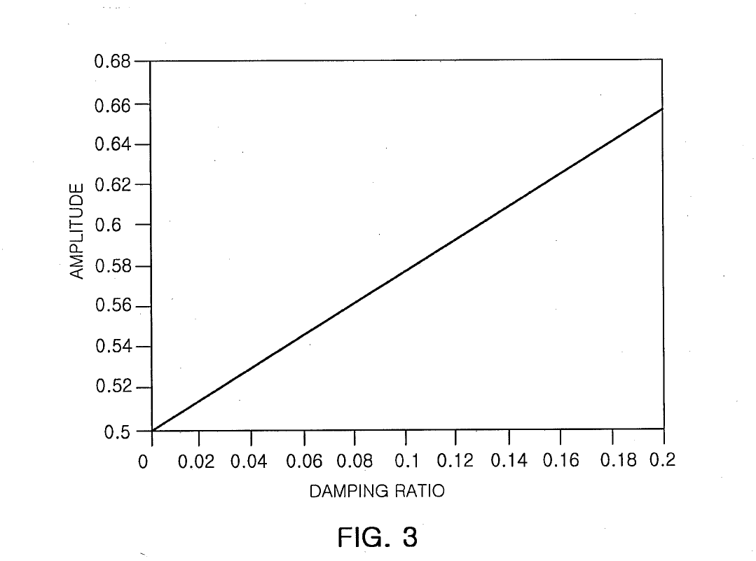

FIG. 3 is a reference diagram showing a coefficient A₁ estimated using a fitting coefficient. A fitting coefficient p used in FIG. 3 may be [0.7762 0.5004].

Therefore, in the case in which the driving signal is generated as the step signal, an amplifier of a first step signal may be associated with the damping ratio of the voice coil motor. Hereinafter, various exemplary embodiments of the present disclosure using this feature will be described.

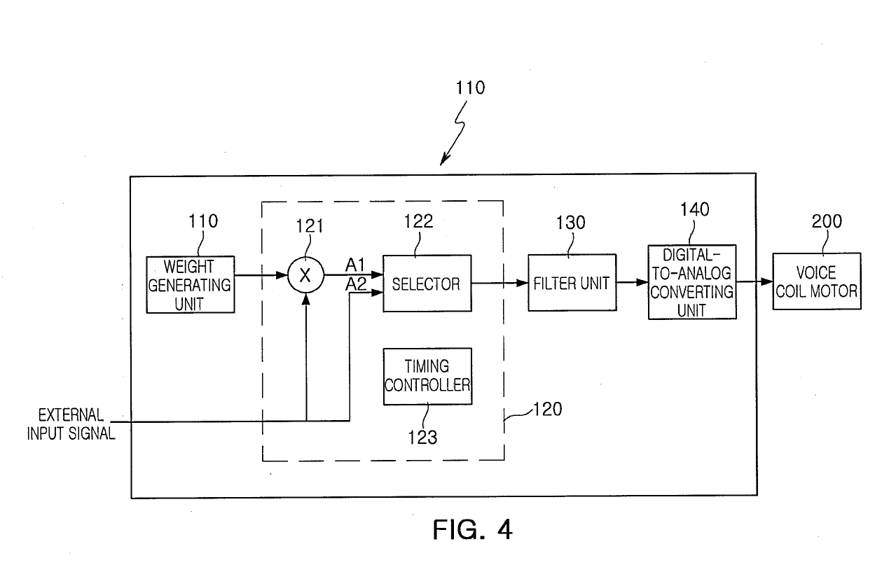

FIG. 4 is a configuration diagram showing an example of a voice coil motor system according to an exemplary embodiment of the present disclosure.

The voice coil motor system may include a voice coil motor apparatus 200 and a motor driving apparatus 100.

The motor driving apparatus 100 may generate a driving signal using a damping ratio of the voice coil motor apparatus 200.

In an exemplary embodiment of the present disclosure, the driving signal may be generated by reflecting a weight generated using the damping ratio in an external input signal. For example, in the case in which the driving signal is a 2-step signal, a ringing phenomenon of the voice coil motor may be decreased by reflecting the weight by the damping ratio in a magnitude, that is, an amplitude, of the step signal in an exemplary embodiment of the present disclosure.

In an exemplary embodiment of the present disclosure, the motor driving apparatus 100 may include a weight generating unit 110 and a driving signal generating unit 120. In an exemplary embodiment of the present disclosure, the motor driving apparatus 100 may further include at least one of a filter unit 130 and a digital-to-analog converting unit 140.

The weight generating unit 110 may generate a weight of the external input signal using a damping ratio of a motor apparatus (voice coil motor apparatus in an example shown in FIG. 6).

In an exemplary embodiment of the present disclosure, the weight generating unit 110 may generate the weight during each period of the driving signal.

The weight generated by the weight generating unit 110 may be linearly proportional to the damping ratio of the motor apparatus, as described above.

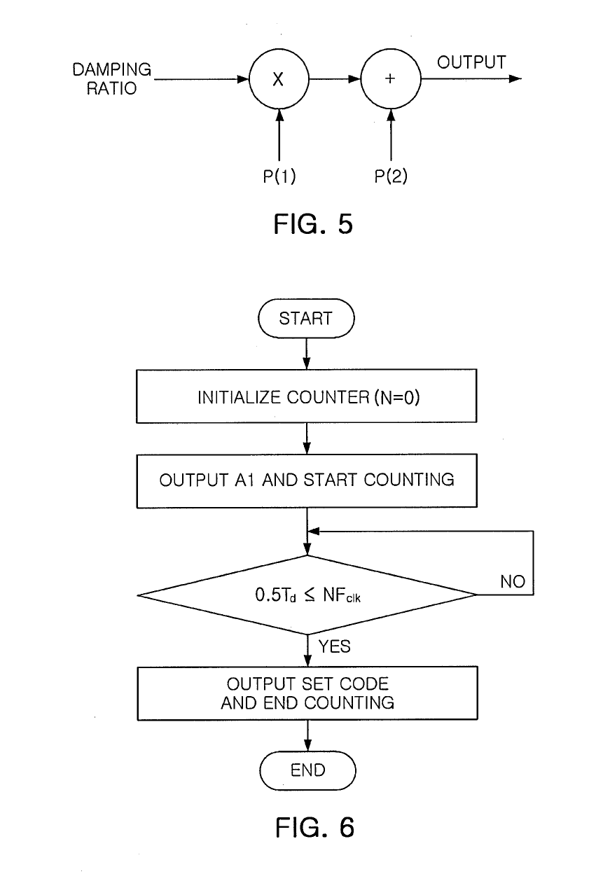

FIG. 5 is a reference diagram showing an example of a weight generating unit of FIG. 4. Referring to FIG. 5, the weight generating unit 110 may generate the weight using Mathematical Equation 20.

[Mathematical Equation 20]

α=p(1)*zeta+p(2)

Here, zeta is a damping ratio, and p(1) and p(2) indicate fitting coefficients.

The generated weight may be provided to the driving signal generating unit 120, and the driving signal generating unit 120 may generate the driving signal using the weight.

The driving signal generating unit 120 may generate a first signal A₁ and a second signal A₂ and may generate the driving signal including the first and second signals.

The driving signal generating unit 120 may generate the first signal A₁ by reflecting the weight in the external input signal. In addition, the driving signal generating unit 120 may use the external input signal as the second signal A₂.

In an exemplary embodiment of the present disclosure, the driving signal generating unit 120 may include a synthesizer 121, a selector 122, and a timing controller 123.

The synthesizer 121 may generate the first signal A₁ by reflecting the weight in the external input signal.

The selector 122 may receive the first signal A₁ and the second signal A₂ and output the first signal or the second signal. That is, the selector 122 may output the first signal or the second signal as the driving signal depending on controlling by the timing controller 123.

The timing controller 123 may determine output timing of the first signal or the second signal and provide the determined output timing to the selector 122.

FIG. 6 is a reference diagram showing an example of a timing controller of FIG. 4.

FIG. 6 shows an example in which the timing controller controls timing to output the first signal A₁ to which the weight is assigned during a first half of one period T_{d} of the driving signal and to output the second signal A₂ to which the weight is not assigned during a second half of period T_{d} of the driving signal.

Again referring to FIG. 5, when an operation starts, the timing controller 123 first initiates a counter and performs a control to output the calculated A₁. The timing controller 123 may perform counting to confirm whether a time difference of 0.5 T_{d} has been generated. When the time difference of 0.5 T_{d} is sensed, the timing controller 123 may output an input signal and end the counting.

The filter unit 130 may low-pass-filter the driving signal output from the driving signal generating unit 120.

The filter unit 130 may include a low pass filter (LPF) that may shape the driving signal. As an example, the filter unit 130 may be implemented by a 1st infinite impulse response (IIR) filter.

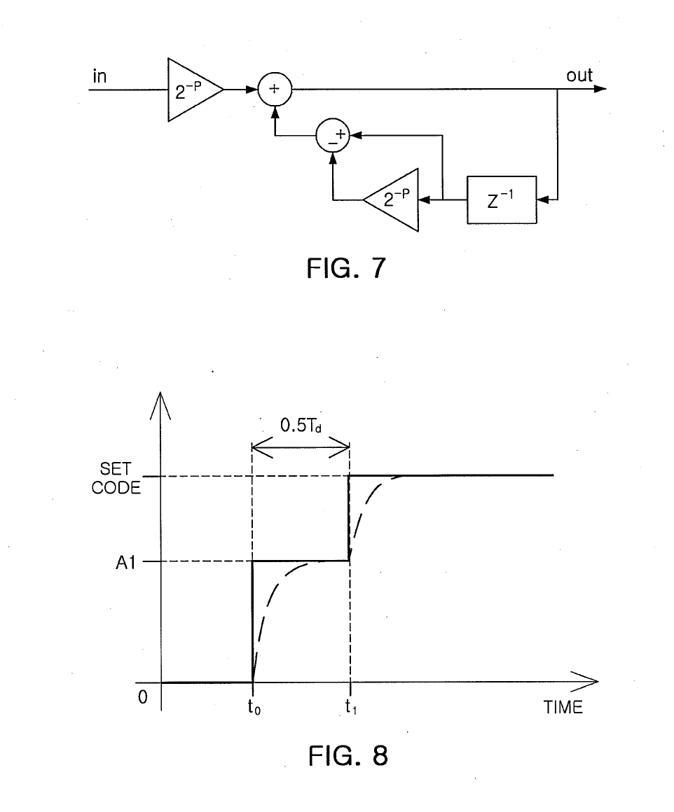

FIG. 7 is a reference diagram showing an example of a filter unit of FIG. 4.

Here, a transfer function of a filter may be represented by Mathematical Equation 21.

$$H ( z ) = \frac{{2}^{- P}}{1 - ( 1 - {2}^{- P} ) {z}^{- 1}} \qquad [ Mathematical Equation 21 ]$$

This may be represented by Mathematical Equation 22, which is a difference equation.

[Mathematical Equation 22]

y(n)=(1−2̂^{-P})*y(n−1)+2̂^{-P}*x(n)

In addition, an effective cut-off frequency of the filter may be represented by Mathematical Equation 23.

$${F}_{c} = \frac{{2}^{- P}}{2 π} - {F}_{s} \qquad [ Mathematical Equation 23 ]$$

Here, Fₛ is a sampling frequency.

The digital-to-analog converting unit 140 may perform digital-to-analog conversion on the driving signal and provide the converted signal to the voice coil motor apparatus.

FIG. 8 shows an example of a driving signal output from a motor driving apparatus. As shown in FIG. 8, the driving signal may be a digital pulse signal or may be a step signal including a first signal continued until a first time and a second signal continued after the first time.

A dotted line shown in FIG. 8 is a driving signal on which shaping is completed by the filter unit 130.

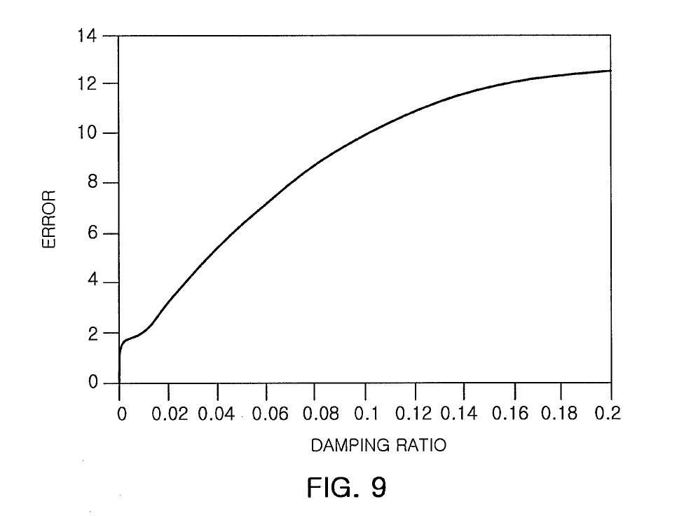

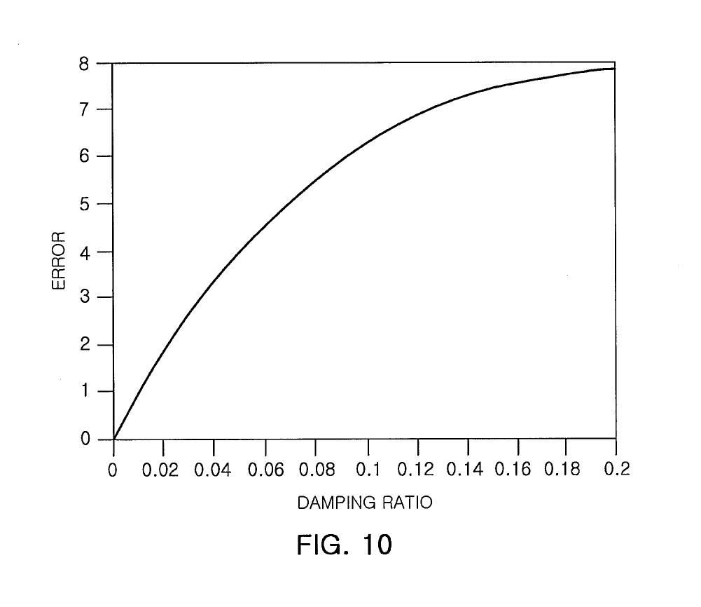

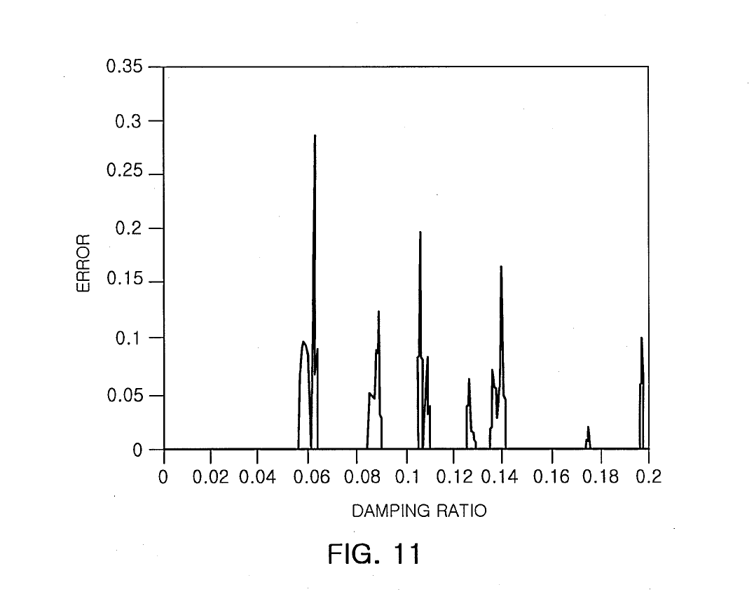

FIGS. 9 and 10 are reference graphs showing a vibration error according to the related art; and FIG. 11 is a reference graph showing a vibration error according to an exemplary embodiment of the present disclosure.

FIG. 9 shows an error of residual vibrations in the case in which ringing compensation is performed by allowing magnitudes of a 2-step driving signal to be the same as each other. It may be seen from FIG. 9 that an error of 12% or more occurs as a damping ratio is increased.

FIG. 10 shows performance for a linear driving signal scheme. It may be seen from FIG. 10 that an error is decreased as compared with FIG. 9; however, an error of about 8% occurs as a damping ratio is increased.

FIG. 11 shows performance according to an exemplary embodiment of the present disclosure. It may be appreciated that an error has been significantly decreased in an exemplary embodiment of the present disclosure as compared with schemes according to the related art. The reason is that the residual vibrations are significantly decreased by controlling a step magnitude (amplitude) of an applied pulse depending on the damping ratio of the voice coil motor in an exemplary embodiment of the present disclosure. That is, the reason is that the driving signal has a feature that vibrations thereof are significantly decreased by controlling the weight reflected in the output signal during each period.

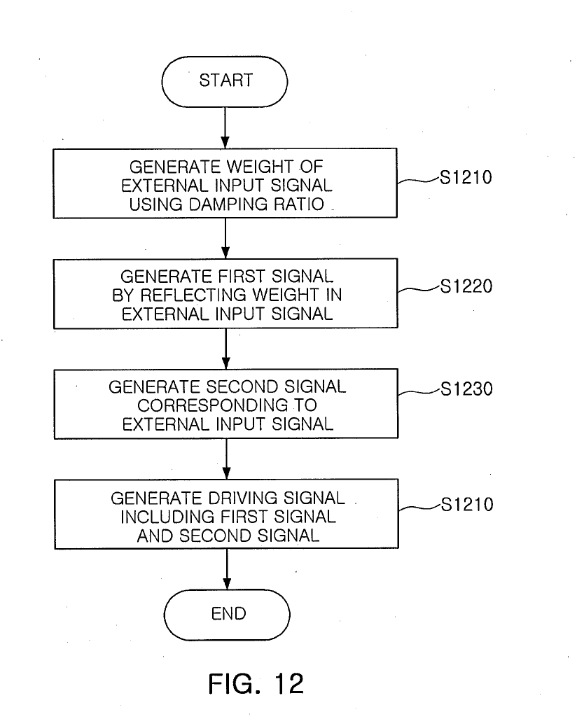

FIG. 12 is a flow chart for describing a motor driving method according to an exemplary embodiment of the present disclosure.

Since a motor driving method to be described below with reference to FIG. 12 is performed by the motor driving apparatus described above with reference to FIGS. 1 through 11, a description that is the same as or corresponds to the above-mentioned description will be omitted.

Referring to FIG. 12, the motor driving apparatus 100 may generate the weight of the external input signal using the damping ratio of the motor apparatus (S1210).

The motor driving apparatus 100 may generate the first signal A₁ by reflecting the weight in the external input signal (S1220), and may generate the second signal corresponding to the external input signal (S1230).

The motor driving apparatus 100 may generate the driving signal including the first signal and the second signal (S1240), and may provide the generated driving signal to the motor apparatus.

In an example of S1210, the motor driving apparatus 100 may calculate the weight a using the following Equation.

α=p(1)*zeta+p(2)

Here, zeta is the damping ratio, and p(1) and p(2) indicate the fitting coefficients.

In an exemplary embodiment of the present invention, the driving signal, which is a digital signal, may be a step signal including the first signal continued until the first time and the second signal continued after the first time.

The motor driving apparatus 100 may repeatedly perform S1210 to S1240 during each period of the driving signal.

As set forth above, according to exemplary embodiments of the present disclosure, the driving signal is generated by reflecting the weight using the damping ratio of the motor apparatus to prevent a resonance phenomenon of the voice coil motor and a ringing phenomenon due to the resonance phenomenon, whereby the driving of the voice coil motor may be more accurately controlled.

While exemplary embodiments have been shown and described above, it will be apparent to those skilled in the art that modifications and variations could be made without departing from the spirit and scope of the present disclosure as defined by the appended claims.

What is claimed is:

1. A motor driving apparatus comprising:
a weight generating unit generating a weight of an external input signal using a damping ratio of a motor apparatus; and
a driving signal generating unit generating a driving signal including a first signal generated by reflecting the weight in the external input signal and a second signal corresponding to the external input signal.

2. The motor driving apparatus of claim 1, wherein the weight is linearly proportional to the damping ratio of the motor apparatus.

3. The motor driving apparatus of claim 1, wherein the driving signal is a step signal including a first signal continued until a first time and a second signal continued after the first time.

4. The motor driving apparatus of claim 3, wherein the driving signal generating unit includes:
a synthesizer generating the first signal by reflecting the weight in the external input signal;
a selector receiving the first signal and the second signal and outputting the first signal or the second signal; and
a timing controller determining output timing of the first signal or the second signal and providing the determined output timing to the selector.

5. The motor driving apparatus of claim 1, further comprising a filter unit low-pass-filtering the driving signal output from the driving signal generating unit.

6. The motor driving apparatus of claim 1, wherein the external input signal and the driving signal are digital signals, and
the motor driving apparatus further comprising a digital-to-analog converting unit performing digital-to-analog conversion on the driving signal and providing the converted signal to the motor apparatus.

7. The motor driving apparatus of claim 1, wherein the weight generating unit calculates the weight a using the following Equation:
α=p(1)*zeta+p(2)
where zeta is the damping ratio, and p(1) and p(2) indicate fitting coefficients.

8. A voice coil motor system comprising:
a voice coil motor apparatus; and
a motor driving apparatus generating a driving signal using a damping ratio of the voice coil motor apparatus,
wherein the driving signal is generated by reflecting a weight generated using the damping ratio in an external input signal.

9. The voice coil motor system of claim 8, wherein the motor driving apparatus includes:
a weight generating unit generating the weight of the external input signal using the damping ratio of the voice coil motor apparatus; and
a driving signal generating unit generating a driving signal including a first signal generated by reflecting the weight in the external input signal and a second signal corresponding to the external input signal.

10. The voice coil motor system of claim 9, wherein the driving signal generating unit includes:
a synthesizer generating the first signal by reflecting the weight in the external input signal;
a selector receiving the first signal and the second signal and outputting the first signal or the second signal; and
a timing controller determining output timing of the first signal or the second signal and providing the determined output timing to the selector.

11. The voice coil motor system of claim 9, wherein the weight generating unit calculates the weight a using the following Equation:
α=p(1)*zeta+p(2)
where zeta is the damping ratio, and p(1) and p(2) indicate fitting coefficients.

12. A motor driving method performed by a motor driving apparatus for driving a motor apparatus, comprising:
generating a weight of an external input signal using a damping ratio of the motor apparatus;
generating a first signal by reflecting the weight in the external input signal;
generating a second signal corresponding to the external input signal; and
generating a driving signal including the first signal and the second signal.

13. The motor driving method of claim 12, wherein in the generating of the weight, the weight a is calculated using the following Equation:
α=p(1)*zeta+p(2)
where zeta is the damping ratio, and p(1) and p(2) indicate the fitting coefficients.

14. The motor driving method of claim 12, wherein the driving signal is a digital signal and is a step signal including a first signal continued until a first time and a second signal continued after the first time.

15. The motor driving method of claim 12, wherein the generating of the weight, the generating of the first signal, the generating of the second signal, and the generating of the driving signal are repeatedly performed during each period of the driving signal.
